(19) United States
(12) Patent Application Publication
(10) Pub. No.: US 2023/0136677 A1
(43) Pub. Date: May 4, 2023

(54) MAGNETIC WEDGE CLAMP FOR A STRAP

(71) Applicant: Christophe PRIER, Guipry Messac (FR)

(72) Inventor: Christophe PRIER, Guipry Messac (FR)

(21) Appl. No.: 17/906,586

(22) PCT Filed: Mar. 17, 2021
(86) PCT No.: PCT/IB2021/052224

§ 371 Date: Sep. 16, 2022

(30) Foreign Application Priority Data
Mar. 19, 2020 (FR) 2002709

(51) Int. Cl. B60P 7/08

(52) U.S. Cl. CPC B60P 7/0853

(57) ABSTRACT

A tool for holding a tie-down strap, which comprises a plate (1) and a magnet (2, 3), wherein the plate extends between a first surface, a second surface and an edge, wherein the magnet extends over a first height from the first surface, wherein the magnet is in mechanical contact with the first surface, wherein the plate comprises notches, wherein the notches comprise a first notch and a second notch, wherein the length of the first notch is of the order of magnitude of the width of a tie-down strap, wherein the width of the first notch is of the order of magnitude of the thickness of a tie-down strap, wherein the depth of the first notch is equal to the thickness of the plate, wherein the length of the second notch is of the order of magnitude of the width of a tie-down strap, wherein the width of the second notch is of the order of magnitude of the thickness of a tie-down strap, wherein the depth of the second notch is equal to the thickness of the plate, wherein the first notch and the second notch are guided in a first direction and wherein the magnet extends over the first surface between the notches and the edge of the plate along a first length and along a first width.

The invention relates to the general field of transport and logistics and the particular field of the installation by a single operator of an adjustable-length tie-down strap having hooks, for the purpose of keeping freight in place on a transport vehicle equipped with a metal body made of iron or ferromagnetic metal.

The secure placement of freight or goods on transport vehicles or their trailers by a single operator is commonly carried out by means of tightening straps fitted at their ends with metal hooks allowing them to be supported on an edge of the body of the vehicle or its trailer and provided with various means known in the prior art, which allow adjustment and tightening of the length of the strap.

The conventional use of a such a strap in the prior art is as follows: the operator positions the strap around the freight, then positions a first hook by bringing it into mechanical contact with the body of the vehicle. The operator then lets go of the first hook to reach the second hook, positions the second hook on the body and tightens the strap using the adjustment and tightening means.

In practice, the release of the first hook by the single operator may result in the hook no longer being held in place, and the possibility of movement of the first hook along the vehicle body. This therefore creates a risk of detachment of the first hook during tightening.

To solve this problem, the prior art uses a strap provided with hooks made of magnetic material or hook-shaped magnets, to magnetically immobilize the hooks relative to the body of a vehicle when securing cargo to the vehicle using the strap. However, this solution requires equipment with magnets used for all the hooks.

Improving the safety of securing cargo by a strap on a transport vehicle by a single operator thus remains a difficult problem in the prior art.

In this context, the invention is a tool for holding a tie-down strap that comprises a plate and a magnet, wherein the plate extends between a first surface, a second surface and an edge, wherein the magnet extends a first height from the first surface, wherein the magnet is in mechanical contact with the first surface, wherein the plate includes notches, wherein the notches include a first notch and a second notch, wherein the length of the first notch is of the order of magnitude of the width of a tie-down strap, wherein the width of the first notch is of the order of magnitude of the thickness of a tie-down strap, wherein the depth of the first notch is equal to the thickness of the plate, wherein the length of the second notch is of the order of magnitude of the width of a tie-down strap, wherein the width of the second notch is of the order of magnitude of the thickness of a tie-down strap, wherein the depth of the second notch is equal to the thickness of the plate, wherein the first notch and the second notch are directed in a first direction and wherein the magnet extends over the first surface, between the notches and the edge of the plate along a first length and along a first width.

In variations:

The first direction consists essentially of a direction perpendicular to the first length.
the magnet comprises a first stud and a second stud, the first stud is magnetized, the second stud is magnetized and the first stud and the second stud are spaced apart on the first surface, along the first length.
the magnet comprises a block, the block is magnetized and the block is elongated on the first surface, according to the first length.
the first height is of the order of magnitude of the thickness of a securing strap.
the first surface is concave, the first surface is bent along a first axis and the magnet is in mechanical contact with the first surface, between the first axis and the notches.
the mechanical contact between the plate and the magnet comprises a mechanical bond.
the plate is stamped in the area of the mechanical bond.

The invention also relates to a method for holding a securing strap on a ferromagnetic vehicle body using an apparatus as above, comprising the following steps: passing the strap through the notches and magnetically attaching the magnet to the ferromagnetic vehicle body.

Alternatively, the method includes the following additional step: removing the apparatus from the strap and sliding the strap along the notches.

Detailed embodiments of the present invention are described below with reference to the following figures for the numbers in parentheses:

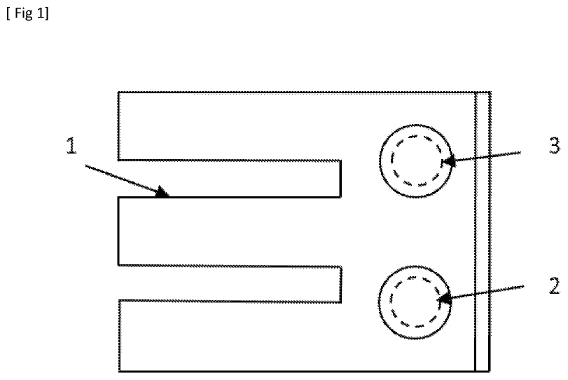

FIG. 1: shows, in a front view, a plate comprising three fingers having a length corresponding to a tie-down strap and two magnets glued to the plate at a distance from the end of the fingers which is greater than or equal to the length of the fingers, and perpendicular to the direction of the fingers or to the notches which define the fingers by removal of material.

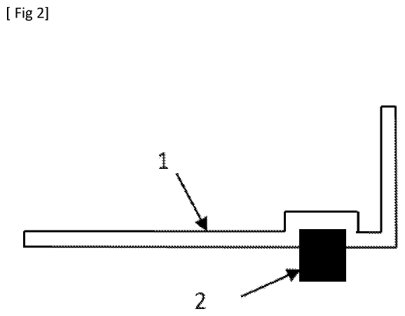

FIG. 2: shows a side view of the apparatus of FIG. 1.

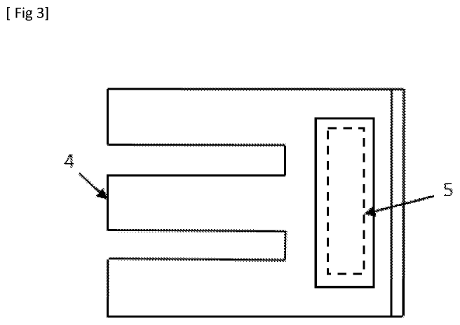

FIG. 3: shows in a front view, a plate comprising three fingers having a length corresponding to a tie-down strap and an elongated magnetic block glued to the plate at a distance from the end of the fingers greater than or equal to the length of the fingers such that the length or greater spatial extension of the magnet is perpendicular to the directions of the fingers or to the direction of the notches which define the fingers by removal of material.

All the embodiments of the invention are intended to hold in place a freight securing means or securing strap on a ferrous or ferromagnetic body of a transport vehicle during its assembly by a single operator. Such securing means or securing strap, within the meaning of the present application, consists of all the embodiments of a flat strap or strap within the meaning of the present application, provided at each of its ends with a metal attachment, in the shape of a hook, thicker than the strap, and comprising on the one hand a first part of a hook or hook loop of the same width as the strap, which is passed through a loop of the strap sewn around the first hook part and further comprising a second hook part or hook shank or hook, curved at an angle less than or equal to ninety degrees (90°). The hook shank is of a width less than the width of the flat strap and of a thickness greater than the thickness of the flat strap. The arrangement of the hook to be secured to the vehicle body will be assumed to be with the hook suspended by gravity by the strap.

However, it is understood that the invention applies to any type of hook, in particular those whose width is greater than or equal to the width of the strap, provided that the magnetic strength or magnetic securing capacity, or the magnetization of the magnet chosen for the invention, is adapted to the weight of the strap portion and hook to be magnetically secured to a ferromagnetic body. The invention is therefore largely independent of the type or shape of the hooks, which are very variable and only dependent on the flat strap, the shape of which is not very variable, which makes it possible to use the invention for the vast majority of tie-down straps in a universal manner.

The orders of magnitude of the thickness of the elements of the securing means for the present application are as follows:

The thickness of the strap is of the order of a few millimeters (mm), this thickness being doubled in the sewn part in the vicinity of the first hook part;
The thickness of the hook is of the order of a centimeter, typically one centimeter and the width of its shank is generally twice its thickness, typically two centimeters, the hook being commonly made from a single solid tube in a loop shape arranged so that its ends are joined at the hook shank or sometimes separate and parallel;
The length of the hook shank is of the order of a decimeter (dm), typically eight to ten centimeters (8 to 10 cm);
The width of the strap is of the order of a decimeter (dm), typically five centimeters (5 cm);
The length of the strap is of the order of a decameter (dam), typically between five and fifteen meters (5 m to 15 m), for example 12m.

In all embodiments, the invention will include a plate provided with at least two notches on its edge, which defines at least three fingers in said plate. These fingers will be arranged, for example, parallel to one another, and if we take the analogy of a human hand for the plate, a magnet will be placed in the palm of the hand or plate, that is to say in an area away from the fingers. It will thus be possible to obtain the technical effect of the invention, which is to stick a flat strap held between the fingers of a plate on a ferromagnetic metal surface, by means of a plate that is magnetic or that is equipped with a magnet or magnetic portion, and thus keep the flat strap and a hook at its end in place without the presence of an operator. It will thus be possible to completely position the securing strap and to tension it with a single operator, conveniently, then to remove the fingered plate by sliding the notches along the strap to leave the strap in place and reuse the tool for another strap. The plate can in all the embodiments be bent to make it possible to eliminate the magnetic contact between the magnet and the vehicle body with less effort due to a flange formed by the bend that enables gripping of the plate or the insertion of user's fingers between the plate and the vehicle body to lift the magnet and facilitate removal of the plate in the direction of the width of the strap or flat strap.

Referring to FIGS. 1 and 2, a first embodiment of the present invention, which is the preferred embodiment, is an embodiment having three fingers of length equal to the width of a strap for which one of the hooks is to be temporarily secured on the body of the vehicle used. The three fingers are formed by cutting two notches of the same thickness as the plate, i.e., crossing the plate. The plate will be made of a rigid material, for example a metal such as stainless steel, or even a plastic or a composite material. The plate extends between a first face or surface and a second face or surface, to a plate edge or perimeter. The length of the notches in the plate is of the order of magnitude of the width of the strap. Two magnetic studs, i.e., a first stud (2) and a second stud (3), are secured to the plate (1), for example by gluing on the first face, possibly in a stamping made in a metal plate or in a recess of a plastic plate, which facilitates the positioning and gluing of the magnets. Any other means of securing the magnets to the plate (crimping, injection) would be equivalent for obtaining positioning and attachment in this embodiment.

The space between the middle finger and another finger, or the space between the fingers or the interdigital space, is of the order of magnitude of the thickness of the securing strap for which the device according to the invention is intended. The magnets are located at a distance from the ends of the fingers that is greater than the length of the fingers, and at the greatest possible distance between them, to improve magnetic adhesion. If it is desired to use the invention in a situation where this thickness is doubled, the interdigital space may be chosen as twice the thickness of the strap, excluding the seams near the hooks.

The use of the device of this first embodiment involves a first step of mechanically attaching the tie-down strap to the apparatus of the invention, by threading the strap between the fingers, then in a second step attaching the apparatus magnetically to the body of the vehicle.

In the first step, the strap is folded into a loop close to one of the hooks of the securing means, or first hook, and the finger located in the middle of the three fingers of the plate is inserted therein, then the loop is released and the strap is threaded between the fingers. The mechanical friction of the strap on the edges of the fingers enables the securing of the strap and of the hook relative to the fingers of the plate, while retaining the ability to separate the plate from the strap by sliding the width of the strap along the length of the fingers.

In the second step of this first embodiment, the magnets and the vehicle body are brought into magnetic contact, which will be ferromagnetic, that is to say allowing magnetic attachment of the magnets to the vehicle body. A dimension of the studs from the first face or height of the studs relative to this surface will be chosen to be of the order of magnitude of the thickness of the strap from the fingers or height of the strap above the fingers. It is thus possible to obtain good magnetic adhesion, which makes it possible to counteract movements of the strap when it is put in place and is under tension, and to preserve the positioning of the first hook on the vehicle body, independent of the weight of this hook and the weight or movement of the strap. A person skilled in the art will be capable of easily determining an appropriate type of magnet, in particular a neodymium magnet, that makes it possible to obtain the independence of the positioning of the first hook vis-à-vis the subsequent movements of the strap for each particular tie-down strap and first hook of a given weight.

In a preferred positioning embodiment, the center finger will be positioned between the strap snaking between the fingers and the vehicle body.

Once the second hook has been put in place and the strap tensioned, it is possible to remove the plate by sliding the fingers of the plate along the width of the strap under tension. It is thus possible to reuse the inventive tool or device indefinitely, for the establishment of one or more other securing straps.

Finally, a flange acting as a handle will be used to facilitate gripping and removal of the plate despite the pressure of the strap on the plate fingers, that is to say by making convex the face of the plate in contact with the magnets, for example by bending it in a region away from the fingers and beyond the magnet, so as to form a flange having an angle of approximately 90° relative to the rest of the face of the plate containing the fingers.

Referring to FIG. 3, in a second embodiment, and use, of the apparatus of the invention, a plate (4) is provided with the same fingers or notches and the same characteristics as in the first embodiment, but with a magnet which is an elongated block (5) glued to the first face of the plate (4).

In both embodiments, a handle can be created for the plate: either by bending the plate along an axis to form a flange such that the magnet is located between the bending axis and the fingers; or by fixing a handle on the plate. In this arrangement, it will be possible to lift the fingers of the plate, in which the tensioned strap is threaded, using the handle to tilt the magnet and remove the plate even in the presence of a flat strap that is tensioned and pressing on the fingers of the plate.

The invention is capable of being produced according to numerous variations in which the mechanical dimensions of the device of the invention will be chosen to allow the use of the invention with different strap thicknesses in order to increase the field of use of the invention without sacrificing the effectiveness of holding the flat strap in place, once positioned.

Orders of magnitude of the dimensions, typical of the elements of the invention, will be, for example, for the first embodiment, cylindrical magnetic studs 10 mm in diameter and 13 mm in height (or thickness) and for the second embodiment, a magnetic block 3 cm long by 1 cm wide for its bonding surface with a height of 5 mm to 13 mm, preferably between 5 mm and 8 mm, typically 6 mm.

In both embodiments, the plate may be flat, 6 cm wide and 9 cm long, with a thickness of 2 to 3 mm. On the flat surface of the plate, the studs of the first embodiment could, for example, be spaced apart by 25 mm. However, it will be possible, in order to facilitate the removal of the apparatus when the strap is under tension and pressing on its central finger, to bend one or more of the fingers outside the plane of the plate, without departing from the teaching of the invention. The bending angle of the finger(s) will be selected to detach or tilt the magnet(s) under the effect of a definitive tension of the strap, temporarily releasing the tension during an adjustment of the strap, while still allowing the magnets to be reattached to the vehicle body.

The invention is useful or capable of industrial application in the field of logistics and the transportation of goods.

1. An apparatus for holding a tie-down strap, comprising:
a plate having a first surface, a second surface and an edge, wherein the plate includes first notch and a second notch, each having a length of an order of magnitude of a width of a tie-down strap, a width of first notch is of an order of magnitude of a thickness of a tie-down strap, and a depth of the first notch is equal to a thickness of the plate, the first notch and the second notch being oriented in a first direction; and
a magnet in mechanical contact with the first surface that extends from the first surface to a first height, and that is positioned between said notches and said edge of the plate in a region of the first surface having a first length and a first width.

2. The apparatus according to claim 1 wherein the first direction is substantially perpendicular to the first length.

3. The apparatus according to claim 1 wherein the magnet comprises first and second magnetized studs that are spaced apart on the first surface along the first length.

4. The apparatus according to claim 1 wherein the magnet comprises a magnetized block that is elongated on the first surface along the first length.

5. The apparatus according to claim 1 wherein the first height is of the order of magnitude of the thickness of a tie-down strap.

6. The apparatus according to claim 1 wherein the first surface is concave and is bent to a flange along a first bending axis, and wherein the magnet is in mechanical contact with the first surface, between the first bending axis and the notches.

7. The apparatus according to claim 1 wherein the mechanical contact between the plate and the magnet comprises a mechanical bond.

8. The apparatus according to claim 6 wherein the plate is stamped in the area of the mechanical bond.

9. A method for holding a tie-down strap on a ferromagnetic vehicle body using an apparatus according to claim 1, the method comprising:
passing the strap through the notches; and
magnetically attaching the magnet to the ferromagnetic vehicle body.

10. The method according to claim 9 further comprising removing the apparatus from the strap by sliding the strap along the notches.
